(19) United States
(12) Patent Application Publication
(10) Pub. No.: US 2025/0028141 A1
(43) Pub. Date: Jan. 23, 2025

(54) LENS ASSEMBLY AND PROCESSING METHOD OF LENS ASSEMBLY

(71) Applicants: Asphetek Solution (Chengdu) Ltd., Chengdu (CN); Asphetek Solution Inc., Hsinchu (TW)

(72) Inventor: CHEN-CHU HSU, Hsinchu (TW)

(21) Appl. No.: 18/507,327

(22) Filed: Nov. 13, 2023

(30) Foreign Application Priority Data
Jul. 19, 2023 (CN) 202310895742.4

(51) Int. Cl. G02B 7/02

(52) U.S. Cl. CPC G02B 7/021; G02B 7/025

(57) ABSTRACT

A lens assembly comprises a first lens, a second lens, a third lens and a baffle ring. The first lens comprises a first surface. The second lens comprises a second surface, in an assembly direction, the first surface is spaced from the second surface. The baffle ring is positioned between the first lens and the second lens, the baffle ring comprises a first end and a second end, the first end is connected to the first surface, the second end is connected to the second surface, a pouring space is formed between the first surface, the second surface and an inner surface of the baffle ring. And the third lens is formed by solidifying a pouring material poured into the pouring space. The application can improve the production yield of the lens assembly.

### FIELD

The present disclosure relates to field of optical component technology, particularly to a lens assembly and a processing method of a lens assembly.

### BACKGROUND

During lens assembly, bonding surfaces between adjacent lenses is usually pasted by liquid optical adhesive to form the lens assembly. During the bonding process, air gas cavity and surface eccentricity can be easily generated between optical surfaces of the adjacent lenses, and the optical axes of the adjacent lenses can be easily tilted. The thickness of the lens assembly can also be inaccurate when the lenses are not tightly fitted by the optical adhesive, resulting a low the production yield of the lens assembly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view illustrating a lens assembly according to an embodiment of the present disclosure.

FIG. 2 is an exploded schematic view illustrating of the lens assembly in FIG. 1 according to an embodiment of the present disclosure.

FIG. 3 is a cross sectional view illustrating the lens assembly in FIG. 1 according to an embodiment of the present disclosure.

FIG. 4 is a first process diagram illustrating a processing method of the lens assembly in FIG. 1 according to an embodiment of the present disclosure.

FIG. 5 is a second process diagram illustrating a processing method of the lens assembly in FIG. 1 according to an embodiment of the present disclosure.

FIG. 6 is a third process diagram illustrating a processing method of the lens assembly in FIG. 1 according to an embodiment of the present disclosure.

FIG. 7 is a partially cross-sectioned view illustrating the lens assembly in FIG. 1 according to an embodiment of the present disclosure.

FIG. 8 is a partially cross-sectional view illustrating the lens assembly in FIG. 1 according to an embodiment of the present disclosure.

FIG. 9 is another partially cross-sectional view illustrating the lens assembly in FIG. 1 according to an embodiment of the present disclosure.

FIG. 10 is a structural diagram illustrating a part of a baffle ring according to an embodiment of the present disclosure.

FIG. 11 is a structural diagram illustrating another part of the baffle ring in FIG. 10 according to an embodiment of the present disclosure.

FIG. 12 is a sectional view illustrating the baffle ring in FIG. 10 according to another embodiment of the present disclosure.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

Some embodiments of the present application are described in detail. In the case of no conflict, the following embodiments and the features in the embodiments can be combined with each other.

The application provides a lens assembly, which comprises a first lens, a second lens, and a third lens, in which the optical axis of the first lens, the optical axis of the second lens, and the optical axis of the third lens have a high degree of coincidence. The bonding surface between the two adjacent lenses is well fitted, the thickness error of the middle lens is small, and the processing yield of the lens assembly is high.

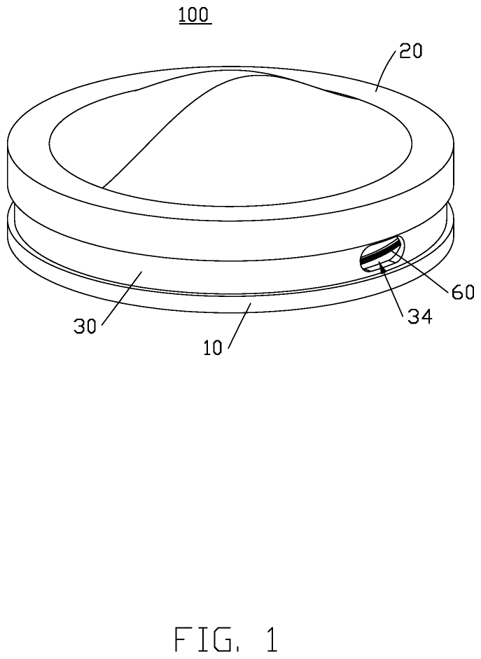

Referring to FIG. 1 to FIG. 3. One embodiment provides a lens assembly 100. The lens assembly 100 includes a first lens 10, a second lens 20, a baffle ring 30, and a third lens 40. The first lens has a first surface 11. The second lens has a second surface 21. The first surface 11 is spaced from the second surface 21 in an assembly direction Y. The baffle ring 30 has a first end 31 and a second end 32. The first end 31 spaced from the second end 32. The first end 31 is connected to the first surface 11. The second end 32 is connected to the second surface 21. A pouring space Q1 is formed between the first surface 11, the second surface 21, and an inner surface of the baffle ring 30. The third lens 40 is formed by pouring a pouring material 91 into the pouring space Q1 and solidifying the pouring material.

In one embodiment, during the processing of the lens assembly 100, the pouring material 91 poured into the pouring space Q1 can be fitted to the first surface 11 of the first lens 10 and the second surface 21 of the second lens 20 to form the third lens 40. Therefore, a surface of the third lens 40 is fitted to the first surface 11, and another surface of the third lens 40 is fitted to the second surface 21. The possibility of gas cavity generated on a joint surface of the first lens 10 and the third lens 40 is greatly reduced. The possibility of gas cavity on the joint surface of the second lens 20 and the third lens 40 is greatly reduced, thus the processing yield of the lens assembly 100 is improved. Furthermore, a distance between the first surface 11 and the second surface 21 in the assembly direction Y is equal to a thickness of the third lens 40 in the assembly direction Y. Therefore, the thickness of the third lens 40 can be adjusted to make the thickness error of the third lens 40 lower and improve the processing yield of the third lens 40, by adjusting the distance between the first lens 10 and the second lens 20 along the assembly direction Y. The light can directly reach the third lens 40 after passing through the first lens 10, so that a light propagation path can be optimized, and the loss of light transmitted by the lens assembly 100 is decreased, the lens assembly 100 can be used in VR equipment to improve the user experience. In addition, before curing the pouring material 91, an optical axis of the first lens 10 is coincided with an optical axis of the second lens 20, so as to ensure that the optical axis of the third lens 40 also coincides with the optical axis of the first lens 10, which greatly reduces the adjustment difficulty of the optical axis coincidence degree of the three lenses, thus the processing yield of the lens assembly 100 is further improved.

In one embodiment, gas cavities in the pouring material 91 are removed before solidification, a combination of the third lens 40 and the first lens 10 and a combination of the third lens 40 and the second lens 20 after solidification also has no gas cavity, so the processing yield of lens assembly 100 is improved.

In addition, in the processing of the lens assembly 100 of one embodiment, there is no bonding element directly positioned between the two lenses between the first lens 10 and the third lens 40, and between the second lens 20 and the third lens 40, which can greatly reduce the internal stress caused by the bonding between the lenses, so the processing quality and processing yield of the lens assembly 100 are improved.

In one embodiment, the first surface 11 of the first lens 10 and a surface of the first lens 10 away from the second lens 20 can be set as a plane surface or a curved surface in the assembly direction Y. A cross section of the first lens 10 can be circular, elliptical, or shaped and so on. In the assembly direction Y, the second surface 21 of the second lens 20 and the surface of the second lens 20 away from the first lens 10 can also be set as a plane surface or a curved surface and so on. The cross section of the second lens 20 can be circular, elliptical, or shaped and so on.

In some embodiment, the cross section of the baffle ring 30 can be set as a circular, elliptical, or other shaped shape, it can be matched with the first lens 10 and the second lens 20.

In some embodiments, the first lens 10 may be a single lens or a stacked multiple lens. And the second lens 20 may be a single lens or a stacked multiple lens.

In one embodiment, the baffle ring 30 can be made of a material with a transmittance of 100%, during the pouring process, the injection state of the pouring material 91 in the pouring space Q1 can be observed, the gas cavity of the pouring material 91 in the pouring space Q1 can be detected and eliminated, so there are no gas cavity in the solidified third lens 40, and the processing yield of the lens assembly 100 is improved. In other embodiments, the baffle ring 30 can also be made of other materials with a transmittance. In one embodiment, the baffle ring 30 can be made of a material with a light transmittance of 0%, it can isolate the propagation of light from the external environment on the inside of the baffle ring 30 to improve the user's experience. In other embodiment, if the baffle ring 30 is made of a material with high light transmittance, a light blocking layer can be set on an outer surface of the baffle ring 30 after the lens assembly 100 is processed, which can also isolate the light propagation and improve the user experience.

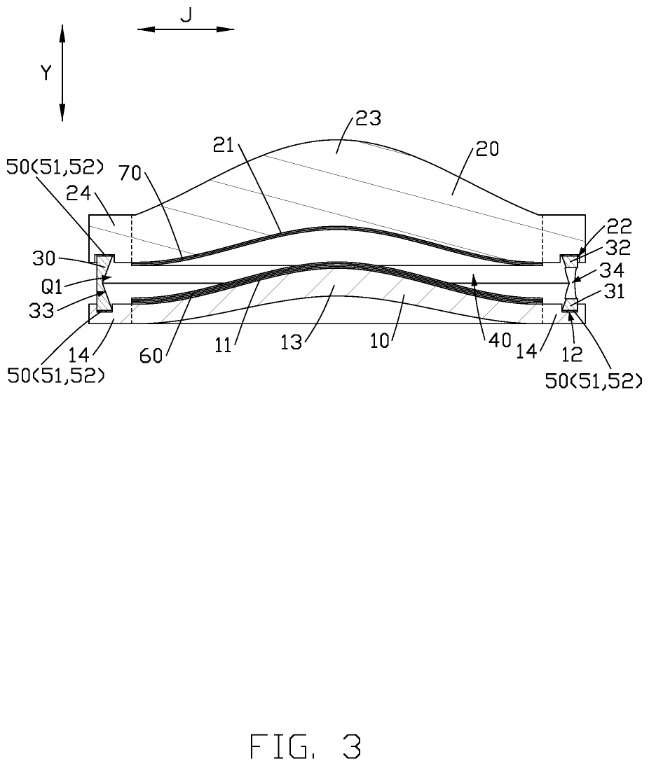

In other embodiments, referring to FIG. 3, the first surface 11 defines a first positioning groove 12. The first end 31 is matched with the first positioning groove 12. The second surface 21 defines a second positioning groove 22. The second end 32 is matched with the second positioning groove 22. The first end 31 and the first lens 10 can be installed easily by the first positioning groove 12, and the first end 31 and the first lens 10 can be not easy moved in connection process and improve the installation accuracy. The second end 32 and the second lens 20 can be installed easily by the second positioning groove 22, and the second end 32 and the second lens 20 can be not easy moved in connection process and improve the installation accuracy.

In other embodiments, referring to FIG. 3, the lens assembly 100 further includes connecting section 50. A first connection sections of the connecting sections 50 is arranged between the first positioning groove 12 and the first end 31. A second connection section of the connecting sections 50 is also arranged between the second positioning groove 22 and the second end 32. The first end 31 is connected to the first lens 10 by the connecting section 50, and the second end 32 is connected to the second lens 20 by the connecting section 50. The connecting sections 50 can be set as solid adhesives 51 or liquid adhesive 52.

The baffle ring 30 and the first lens 10 can be connected quickly by the solid adhesive 51, the baffle ring 30 and the second lens 20 can also be connected quickly by the solid adhesive 51. A relative position of the baffle ring 30 and the first lens 10 or the relative position of the baffle ring 30 and the second lens 20 can be easily adjusted, before the baffle ring 30 and the first lens 10 are not fixed, the solid adhesive 51 can also be used to adjust the position of the baffle ring 30 and the first lens 10. In other embodiment, before the baffle ring 30 and the second lens 20 are not fixed, the solid adhesive 51 can also be used to adjust the position of the baffle ring 30 and the second lens 20. Therefore, the connection efficiency of the baffle ring 30 and the first lens 10 or the baffle ring 30 and the second lens 20 can be improved, and the machining efficiency of lens assembly 100 can be improved.

Liquid adhesive 52 can be filled in the first positioning groove 12 or the second positioning groove 22. For example, the liquid adhesive 52 is fluidity, the liquid adhesive 52 is filled in the first positioning groove 12. The baffle ring 30 is installed in the first positioning groove 12, and the baffle ring 30 is partially placed in the liquid adhesive 52. The distance between the surface of the first end 31 facing the first lens 10 and the bottom surface of the first positioning groove 12 can be adjusted, and the distance between the first lens 10 and the second lens 20 can be further adjusted, so that it can meet the processing thickness size requirements of the third lens 40, and improve the processing accuracy of the third lens 40 and the processing yield of the lens assembly 100. The processing of the first lens 10, the second lens 20 and the baffle ring 30 have certain tolerances, so that the spacing between the first lens 10 and the second lens 20 is also error. By an adjustment space formed by the liquid adhesive 52, it is easy to compare the actual measured spacing size between the first lens 10 and the second lens 20 with the thickness size of the third lens 40 to be processed, until the spacing size between the first lens 10 and the second lens 20 meets the processing requirements of the third lens 40, thus that further improves the processing accuracy of the third lens 40 and the processing yield of the lens assembly 100.

Furthermore, the liquid adhesive 52 is a light-cured colloid, the connection efficiency of the baffle ring 30 and the second lens 20 is improved, and the relative displacement can be avoided between the baffle ring 30 and the second lens 20.

In other embodiments, the thickness of the connecting section 50 is between 50 μm and 300 μm.

In other embodiments, the connecting section 50 can be set as an optically clear adhesive layer (OCA adhesive layer). A curing shrinkage of the connecting section 50 is small, the influence of curing shrinkage on the spacing between the first lens 10 and the second lens 20 can be reduced, so that the error is within the tolerance of the thickness of the third lens 40.

In other embodiments, in the assembly direction Y, the thickness of the third lens 40 is greater than 500 μm.

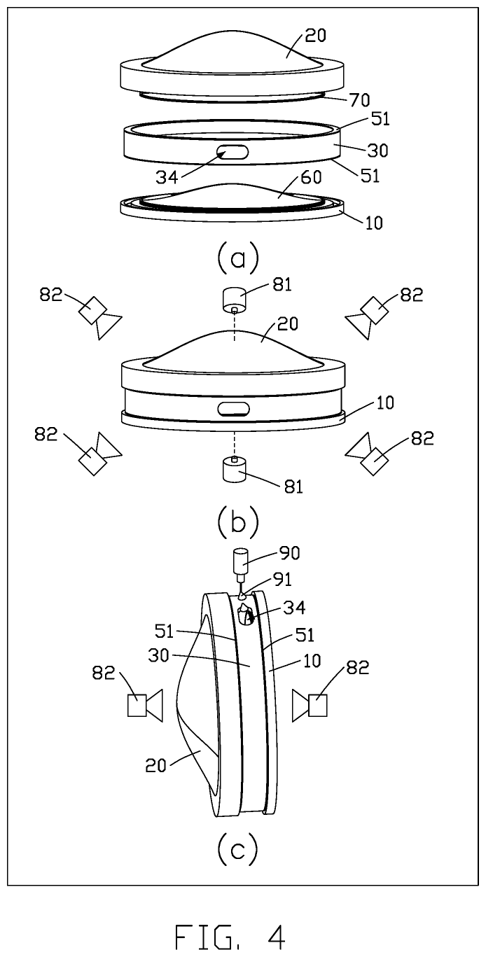

Referring to FIG. 4, when the connecting section 50 between the first end 31 and the first lens 10 is solid adhesive 51, and the connecting section 50 between the second end 32 and the second lens 20 is solid adhesive 51. Referring to FIG. 4, in (a), solid adhesive 51 is pasted on the first end 31 and the second end 32 respectively, and then the first end 31 is placed in the first positioning groove 12, and the second end 32 is placed in the second positioning groove 22. Referring to FIG. 4, in (b), the relative position of the first lens 10 and the second lens 20 is adjusted, so the optical axis of the first lens 10 and the second lens 20 is coincided and the distance between the first lens 10 and the second lens 20 is met the processing thickness requirements of the third lens 40. Referring to FIG. 4, in (c), the first end 31 and the first lens 10 are fixedly connected by solid adhesive 51, the second end 32 and the second lens 20 are fixedly connected, and then the pouring and curing operation of pouring material 91 is carried out by pouring device 90.

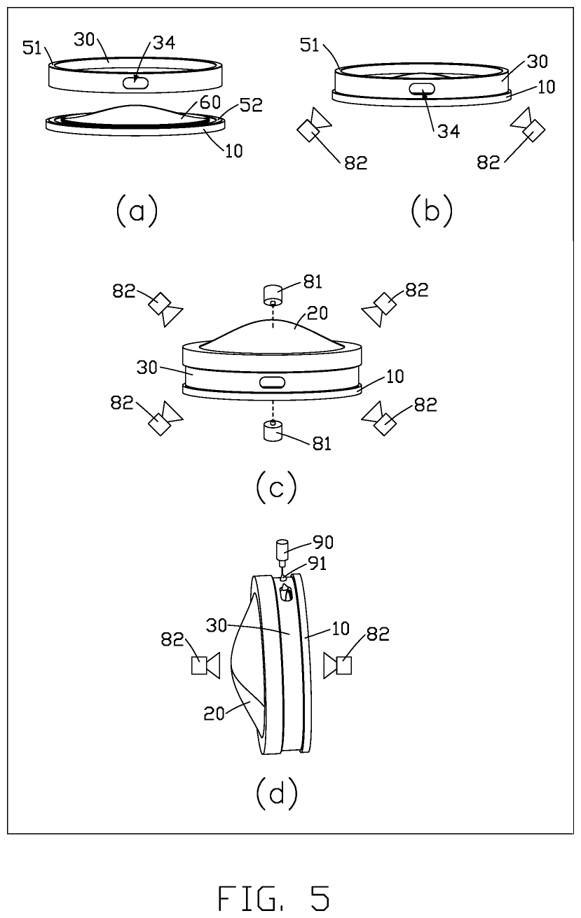

Referring to FIG. 5, when the connecting section 50 between the first end 31 and the first lens 10 is liquid adhesive 52, the connecting section 50 between the second end 32 and the second lens 20 is solid adhesive 51. Referring to FIG. 5, in (a) and FIG. 5, in (b), the liquid adhesive 52 is applied in the first positioning groove 12 of the first lens 10, the solid adhesive 51 is applied in the second end 32, the first end 31 is installed in the first positioning groove 12, the baffle ring 30 is adjusted in the depth of the first positioning groove 12, and the distance of the first lens 10 and the other end of the baffle ring 30 is met the machining thickness dimension requirements of the third lens 40, the solidify liquid adhesive 52 can be connected the first lens 10 with the first end 31. Referring to FIG. 5, in (c), the second lens 20 is set at the second end 32, the second end 32 with solid adhesive 51 is installed in the second positioning groove 22, the relative position of the second lens 20 and the baffle ring 30 are adjusted that the optical axis of the first lens 10 and the second lens 20 can be coincide. Referring to FIG. 5, in (d), the second lens 20 and the second end 32 are fixed by solid adhesive 51, and the pouring materials 91 is poured by the pouring device 90.

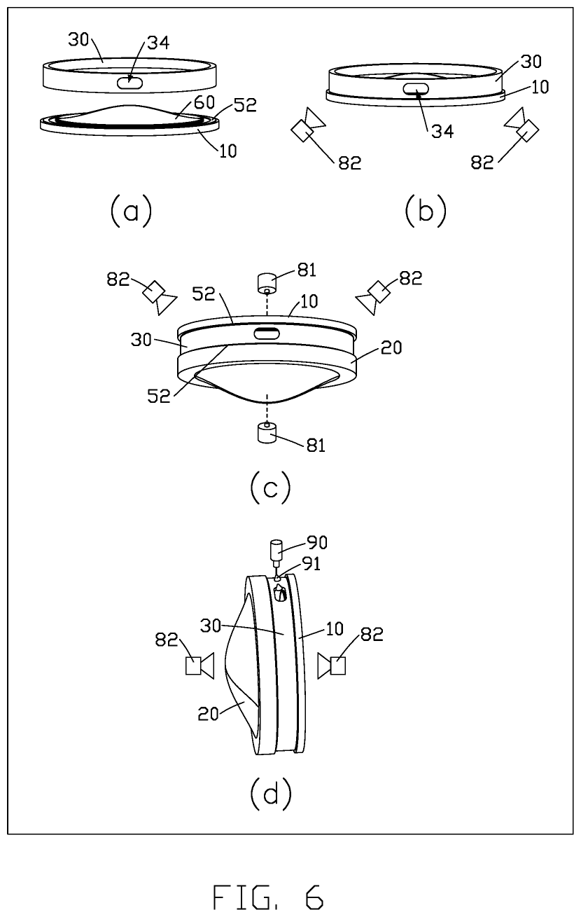

Referring to FIG. 6, when the connecting section 50 between the first end 31 and the first lens 10 is liquid adhesive 52, the connecting section 50 between the second end 32 and the second lens 20 is liquid adhesive 52. Referring to FIG. 6, in (a) and FIG. 6, in (b), the liquid adhesive 52 is applied in the first positioning groove 12 of the first lens 10, the first end 31 is installed in the first positioning groove 12, the first lens 10 and the first end 31 are connected by solidify liquid adhesive 52. Referring to FIG. 6, in (c), the first lens 10 connected with the baffle ring 30 is rotated, the second end 32 is set facing down, the second positioning groove 22 of the second lens 20 is coated with the liquid adhesive 52, the second end 32 is installed in the second positioning groove 22, the relative position of the first lens 10 and the second lens 20 is adjusted to make the optical axis of the first lens 10 and the second lens 20 coincide, and the spacing between the first lens 10 and the second lens 20 meets the machining thickness dimension requirements of the third lens 40. Referring to FIG. 6, in (d), the liquid adhesive 52 in the second positioning groove 22 is solidified to connect the second lens 20 and the baffle ring 30, and the pouring materials 91 is poured by the pouring device 90.

In other embodiments, the shape of the first end 31 is similar with the first positioning groove 12, the first end 31 can be matched the first positioning groove 12, the shape of the second end 32 is similar with the second positioning groove 22, the second end 32 can be matched the second positioning groove 22.

In other embodiments, referring to FIG. 3, the first lens 10 includes a first optical portion 13 and a first connection portion 14, the first connection portion 14 is set at an edge of the first optical portion 13, the first positioning groove 12 is defined at the first connection portion 14, and the first positioning groove 12 is set at intervals with the first optical portion 13. The second lens 20 includes a second optical portion 23 and a second connection portion 24, the second connection portion 24 is set at an edge of the second optical portion 23, the second positioning groove 22 is defined at the second connection portion 24, and the second positioning groove 22 is set at intervals with the second optical portion 23. The first optical portion 13 and the second optical portion 23 are used for light path passage. The first connection portion 14 and the second connection portion 24 are used for structural connections. The first positioning groove 12 is avoided the first optical portion 13, and the second positioning groove 22 is avoided the second optical portion 23, the connection of the first lens 10, the baffle ring 30 and the second lens 20 will not affect the normal operation of the lens assembly 100.

Furthermore, a section shapes of the first positioning groove 12 are varied. At an axial section of the first lens 10 (the section of the optical axis through the first lens 10), a width of an opening 34 of the first positioning groove 12 and a maximum depth of the first positioning groove 12 meet the following requirements. The maximum depth of the first positioning groove 12 is greater than twice the thickness of the connecting section 50, so the first end 31 is stably fitted into the first positioning groove 12, and the first end 31 is reliably supported by the two sides of the first positioning groove 12. Further, the maximum depth of the first positioning groove 12 is less than half of the thickness of the first connection portion 14 to ensure the structural reliability of the first connection portion 14. The width of opening 34 of the first positioning groove 12 shall be greater than the maximum tolerance value of the width of the baffle ring 30 on shaft section, the width of opening 34 of the first positioning groove 12 is less than half of the width of the first connection portion 14, and the width of opening 34 of the first positioning groove 12 shall be less than the minimum tolerance value of the width of the first end 31, so the reliability of the first end 31 and the first positioning groove 12 can be ensured. Furthermore, the first positioning groove 12 is also located between the first connection portion 14 near the inside of the first optical portion 13 and the first connection portion 14 away from the outside of the first optical portion 13, and a spacing between the first positioning groove 12 and the outside of the first optical portion 13 is not less than 1 mm. In addition, when the connecting section 50 is liquid adhesive 52, the height of the liquid adhesive 52 filled in the position groove 12 is not higher than half of the maximum depth of the first positioning groove 12, so the liquid adhesive 52 can be prevented from overflowing when the first end 31 is installed, and the protection effect of the first connection portion 14 and the first optical portion 13, the protection effect of the first connection portion 14 and the second lens 20 can be improved.

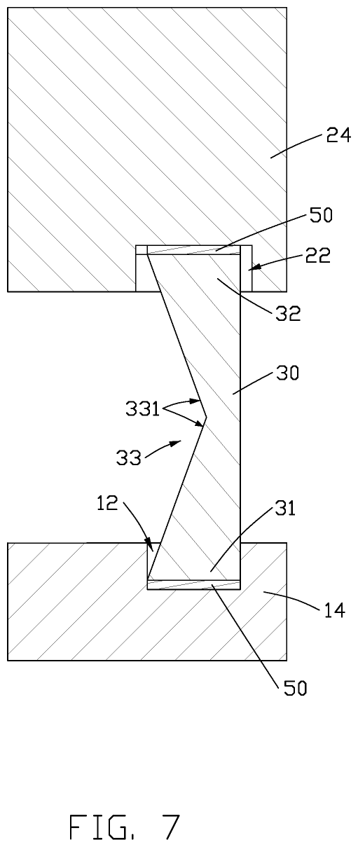

For example, referring to FIG. 7, in the axial section of the first lens 10, the shape of the first positioning groove 12 is rectangular. The width of the first positioning groove 12 is the width at the opening 34 of the first positioning groove 12, and the depth of the first positioning groove 12 is the maximum depth of the first positioning groove 12.

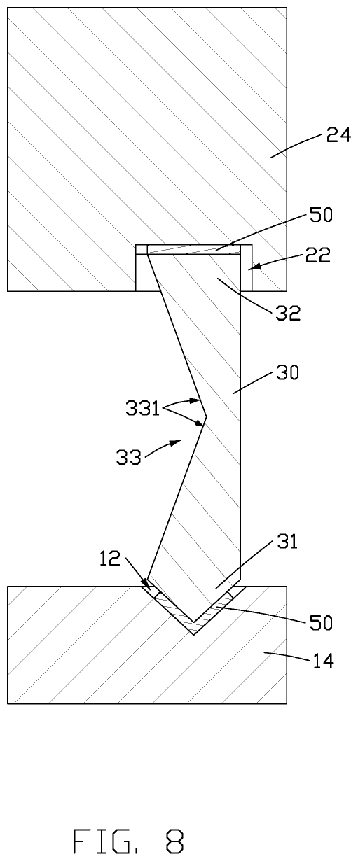

For example, referring to FIG. 8, in the axial section of the first lens 10, the shape of the first positioning groove 12 is an inverted triangle, and the width of the first positioning groove 12 gradually decreases in the direction away from the first surface 11. The depth of the first positioning groove 12 is the distance between the angle of the inverted triangle and the first surface 11. Among them, the first positioning groove 12 includes two intersecting slot side surfaces, and the angle between the two groove side surfaces is greater than 90°, to realize a reliable connection between the first positioning groove 12 and the first end 31.

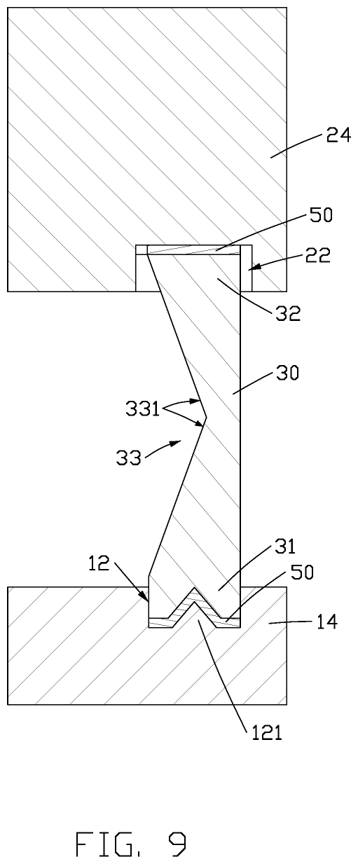

For example, referring to FIG. 9, in the axial section of the first lens 10, the shape of the first positioning groove 12 is a rectangular, and the bottom surface of the first positioning groove 12 is convex with a triangular convex block 121. The width of the first positioning groove 12 is the width at the opening 34 of the first positioning groove 12, and the depth of the first positioning groove 12 is the maximum depth of the first positioning groove 12. The structural complexity of the first positioning groove 12 can be increased by adding the triangular convex block 121, so that the first end 31 is not easily detached from the first positioning groove 12. In addition, the spacing between the two ends of the bottom edge of the triangular convex block 121 and the sides of the first positioning groove 12 is not less than one-tenth of the width of the first positioning groove 12, the possibility of the first end 31 being inclined is avoided when the first end 31 is installed in the first positioning groove 12, and the installation flatness of the first end 31 is be ensured in the first positioning groove 12. The vertex of the triangular convex block 121 is not higher than the first surface 11 to avoid the triangular convex block 121 jacking up the baffle ring 30. Similarly, the angle at the vertex of the triangle convex block 121 is greater than 90°.

In other embodiments, the section of the first positioning groove 12 can also be curved, stepped, trapezoid, inverted trapezoid, oval and other shapes.

In one embodiment, in the machining process, since the relative position of the second lens 20 and the second end 32 is adjusted to achieve the relative position of the optical axis of the first lens 10 and the optical axis of the second lens 20, so the optical axis of the two is coincided. The width of the second positioning groove 22 is greater than the width of the second end 32, as shown in FIG. 7 to FIG. 9, it is convenient to realize the relative movement of the second end 32 and the baffle ring 30 in the radial direction of the second lens 20 and in the assembly direction Y. Moreover, the section shape of the second positioning groove 22 is rectangular, which can improve the radial movement accuracy of the second end 32 and the baffle 30 along the second lens 20. In other embodiments, the cross-section shape of the second positioning groove 22 may also be other shapes.

Specifically, the depth of the second positioning groove 22 is greater than twice the thickness of the connecting section 50, and the depth of the second positioning groove 22 is less than half the thickness of the second connection portion 24, and the second lens 20 is firmly installed with the baffle ring 30, the baffle ring 30 is avoided to shake. The width of the second positioning groove 22 exceeds the width of the second end 32 by approximately 50 microns to 300 microns to provide a reliable adjustment space, and the position of the second end 32 relative to the second lens 20 can be adjusted.

The second positioning groove 22 is also located between the second connection portion 24 near the inside of the second optical portion 23 and the second connection portion 24 away from the outside of the second optical portion 23, and the spacing between the second positioning groove 22 and the outer part of the second optical portion 23 is not less than 1 mm.

In other embodiments, in the producing process, if the relative position of the first lens and the first end 31 is adjusted, the shape of the first positioning groove 12 and the second positioning groove 22 can be exchanged accordingly.

In addition, in one embodiment, there are various ways to achieve the adjustment of the position relationship between the second lens 20 and the first lens 10, for example, referring to FIG. 4 to FIG. 6, the optical axis of the first lens 10 and the optical axis of the second lens 20 are detected by an optical detection instrument 81, and the optical axis of the first lens 10 and the second lens 20 can be determined whether the both is coincided. For example, by providing two image acquisition element 82 on both radial sides of the first lens 10 and the second lens 20, and two image acquisition elements 82 are arranged on both axial sides of the first lens 10 in the assembly direction Y. therefore, four image acquisition elements 82 are arranged around the first lens 10 and the second lens 20. Image information of the first lens 10 and the second lens 20 under different angles can be obtained through four image acquisition elements 82, the relative position relationship between the first lens 10 and the second lens 20 can be determined according to the image information, and the optical axis of the two can be calculated whether the optical axis of the two coincide. Therefore, there are many ways to adjust the position relationship between the first lens 10 and the second lens 20. The image acquisition element 82 can be set up as an industrial camera, etc.

Since the detection accuracy of the image acquisition element 82 is slightly lower than that of the optical detection instrument 81, the position relationship between the first lens 10 and the second lens 20 can be detected by the image acquisition element 82, and coarse adjustment can be made according to the detection results, and then the position relationship between the first lens 10 and the second lens 20 can be detected by the optical detection instrument 81. According to the test results, the position relationship between the first lens 10 and the second lens 20 is adjusted.

In one embodiment, referring to FIG. 3, the baffle ring 30 is provided with an opening 34 connected to the pouring space Q1, the opening 34 is located between the first surface 11 and the second surface 21, in the assembly direction Y. The assembly direction Y is parallel to the gravity direction.

Referring to FIG. 4, FIG. 5, and FIG. 6, after the first lens 10, baffle ring 30 and the second lens 20, the first lens 10 are connected, the first lens 10, the second lens 20 and the baffle ring 30 can be connected by rotating, and the opening 34 is set upward along the assembly direction Y, so the pouring material 91 can be facilitated into the pouring space Q1. Since the opening 34 is set upward, the pouring material 91 is slowly filled from the bottom of the pouring space Q1 to the opening 34, so that the pouring material 91 is not easy to overflow from the opening 34, which greatly reduces the possibility of the pouring material 91 contaminating the first lens 10, the baffle ring 30 or the second lens 20, and improves protection for first lens 10, baffle ring 30, and second lens 20. Furthermore, the pouring way is also relatively simple and convenient, there is no need to set additional complex instruments to prevent the pouring material 91 from leaking, reduce the waste of pouring material 91, and the processing and production costs.

In other embodiment, when the first lens 10, second lens 20 and baffle ring 30 are connected by other ways, or when the first lens 10, second lens 20 and baffle ring 30 are connected by rotating, it has an angle between the baffle ring 30 and the direction of gravity. Under these conditions, after reducing the aperture of the opening 34 and fitting the injection equipment closely to the opening 34, the pouring material 91 can be poured to avoid overflow of the pouring material 91 from the opening 34.

Optionally, the opening 34 is arranged at intervals with the end face of the first end 31, the opening 34 is arranged at intervals with the end face of the second end 32, and the spacing between opening 34 and the one end face of the baffle ring 30 is not less than 0.5 mm, the spacing between opening 34 and the other end face of the baffle ring 30 is not less than 0.5 mm. In addition, after the first end 31 is installed in the first positioning groove 12 and the second end 32 is installed in the second positioning groove 22, the opening 34 shall be located between the bottom surface of the first positioning groove 12 and the bottom surface of the second positioning groove 22, the pouring material 91 is avoided being poured into the first positioning groove 12 or the second positioning groove 22, and the installation position of the baffle ring 30 is accurate and reliable.

In one embodiment, the pouring material 91, the first lens 10 and the second lens 20 can be specified as PMMA (polymethyl methacrylate) composite material, PC material, resin material, etc.

In one embodiment, the pouring material 91 may be made of a photocurable material. In other embodiments, the castable material 91 may also be made of a heat-curable material or a naturally curable material. Moreover, the pouring material 91 shall be made of a material with a small volume or deformation before and after curing to ensure the processing yield of the third lens 40. The optical characteristics of the pouring material 91 are the same or like those of the first lens 10 and the second lens 20, and the optical characteristics are specifically refractive index and penetration rate.

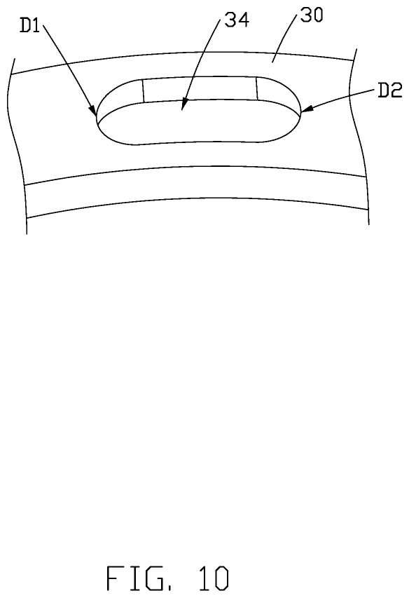

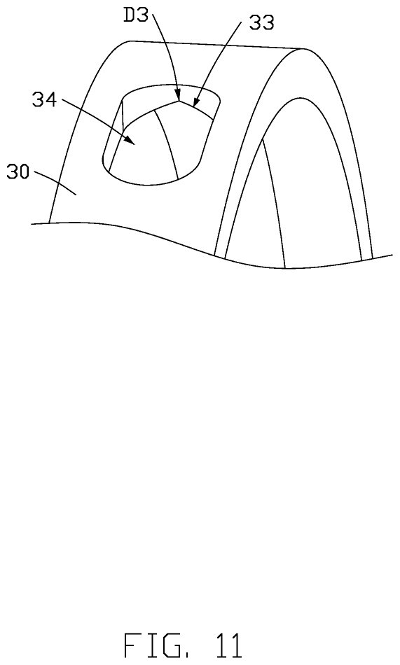

Referring to FIG. 3, FIG. 10, and FIG. 11, an annular groove 33 is defined on the inner surface of the baffle ring 30. The annular groove 33 is internal concaved in a radial direction of the baffle ring 30. Thus, after pouring material 91 is poured into the pouring space Q1, pouring material 91 gradually accumulates from the bottom of pouring space Q1 to opening 34. The pouring material 91 will gradually rise along the inner surface of the baffle ring 30 during the stacking process. Since the pouring material 91 has certain viscosity, the setting of the annular groove 33 can facilitate the inclined rise of the pouring material 91, the inclined annular groove 33 can reduce the possibility of gas cavity between the pouring material 91 and the inner surface of the annular groove 33. Thus, the filling reliability of pouring material 91 is improved, the difficulty of removing gas cavity from pouring material 91 is reduced, the molding efficiency of the third lens 40 is improved, and the molding quality of the third lens 40 is improved. In addition, the shape of the baffle ring 30 can also improve the support of the first lens 10 and the second lens 20 and the reliability of the connection of the first lens 10, the baffle ring 30 and the second lens 20.

Optionally, the annular groove 33 includes two intersecting annular bevels 331. Each of the two annular bevels 331 is inclined from an end surface of the baffle ring 30 to a radial outer side of the baffle ring 30. The annular bevel 331 is a V-shaped cross section. Among them, the width of the narrowest part of the baffle ring 30 is not less than half of the width of the widest part of the baffle ring 30, and the intersection of the two annular bevels 331 can be a sharp angle, or it can be an arc transition angle, R transition angle, etc.

When the section of annular groove 33 is V-shaped, in the radial direction of baffle ring 30, the two ends of the opening 34 are at two points on the outer surface of the baffle ring 30, and the two points are in the direction of the baffle ring 30 (the first convex point D1 and the second convex point D2 as shown in FIG. 10, and the two points are located the outside of the inner surface of the baffle ring 30 and the bottom of the annular groove 33. So, the pouring material 91 can be avoided overflow from both sides of the opening 34, the pouring reliability of the pouring material 91 can be ensured.

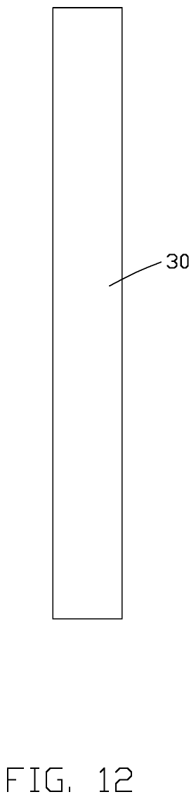

In other embodiments, referring to FIG. 12, the width of the baffle ring 30 can also be equally.

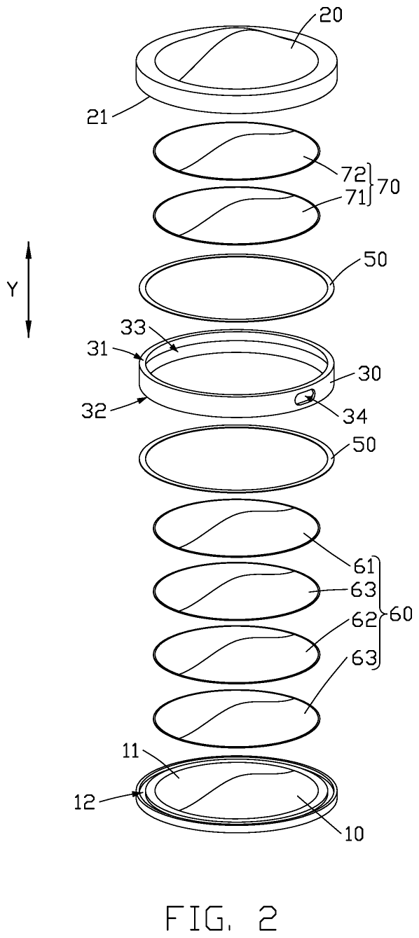

In one embodiment, as shown in FIG. 2 and FIG. 3, the lens assembly 100 also comprises a first film layer 60 and a second film layer 70, the surface of the first lens 10 facing the second lens 20 is provided with a first film layer 60, and the surface of the second lens 20 facing the first lens 10 is provided with a second film layer 70. The first film layer 60 is used to separate the pouring material 91 from the first lens 10. When the refractive index of the cast material 91 is the same or close to the refractive index of the first lens 10, the first film layer 60 can avoid optical path deviation and improve the reliability of the optical path. The second film layer 70 is used to separate the pouring material 91 from the second lens 20, when the refractive index of the cast material 91 is the same or close to the refractive index of the second lens 20, the second film layer 70 can avoid optical path deviation and improve the reliability of the optical path.

Optionally, the first film layer 60 includes a semi-transparent semi-reflective polarizer 61 and a polarizer 62, the polarizer 62 is attached to the first surface 11 of the first lens 10 by a first adhesive 63, and the semi-transparent semi-reflective polarizer 61 is attached to the surface of the polarizer 62 away from the first lens 10 by a first adhesive 63. The first adhesive 63 can be set as an OCA adhesive.

The second film layer 70 includes a quarter-wave plate 71, the quarter-wave plate 71 is bonded to the second surface 21 of the second lens 20 by a second adhesive 72, the second adhesive 72 may be provided as an OCA adhesive. In other embodiments, the specific materials of the first film layer 60 and the second film layer 70 can also be adjusted according to actual requirements.

In the machining process of lens assembly 100, the first film layer 60 is bonded to the first lens 10, the second film layer 70 is bonded to the second lens 20, and then the first lens 10, the baffle ring 30 and the second lens 20 are assembled.

In one embodiment, a processing method of the lens assembly 100 is provided. The method has many steps. In the assembly direction Y, the first lens 10 and the second lens 20 are arranged at intervals, the first lens 10 has a first surface 11 toward the second lens 20, the second lens 20 has a second surface 21 toward the first lens 10; the baffle ring 30 is arranged between the first surface 11 and the second surface 21. The pouring space Q1 is formed through the first surface 11, the second surface 21 and the inner of the baffle ring 30, the baffle ring 30 is provide with an opening 34, the opening 34 is connected the pouring space Q1. The first end 31 of the baffle ring 30 is connected to the first surface 11, the second end 32 of the baffle ring 30 is connected to the second surface 21. The pouring material 91 is injected from the opening 34 to the pouring space Q1, the pouring material 91 in the pouring space Q1 is solidified to form a third lens 40.

After completing the processing of the lens assembly 100, according to the actual processing requirements, the current lens assembly 100 can also be used as a new first lens 10 and/or second lens 20, and then the method can be applied to prepare a new lens assembly 100. When a lens assembly 100 consisting of multiple lenses is processed, multiple lenses are fit well and have good optical performance.

Optionally, the step that the second end 32 of the baffle ring 30 is connected the second surface 21 includes those steps. The liquid adhesive 52 is filled in the second positioning groove 22, the second lens 20 is placed in the baffle ring 30, and the liquid adhesive 52 is filled between the second positioning groove 22 and the second end 32. The second lens 20 is moved in a radial direction J of the second lens 20, the second end 32 is adjusted at the second positioning groove 22 to match the optical axis of the first lens 10 and the optical axis of the second lens 20, and the distance between the first surface 11 and the second surface 21 is within a preset range. In other embodiments, the assembly steps of the first lens 10, the second lens 20, and the baffle ring 30 may also be changed.

Optionally, before injecting the pouring material 91, the first lens 10, the baffle ring 30 and the second lens 20 are connected by rotating, the opening 34 is set upward in the direction of gravity. In other embodiments, the first lens 10, the baffle ring 30, and the second lens 20 can also be assembled without rotation, and the pouring method can be referred to the above description and will not be described here.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens assembly, comprising:
a first lens, comprising a first surface;
a second lens, comprising a second surface, the first surface spaced from the second surface in an assembly direction;
a baffle ring positioned between the first lens and the second lens, the baffle ring comprises a first end and a second end, the first end is connected to the first surface, the second end is connected to the second surface, a pouring space is formed between the first surface, the second surface, and an inner surface of the baffle ring; and
a third lens, formed by pouring a pouring material into the pouring space and solidifying the pouring material.

2. The lens assembly as claimed in claim 1, wherein an annular groove is defined on an inner surface of the baffle ring, the annular groove is concaved in a radial direction of the baffle ring.

3. The lens assembly as claimed in claim 2, wherein the annular groove comprises two intersecting annular bevels, each of the two annular bevels is inclined from an end surface of the baffle ring to a radial outer side of the baffle ring.

4. The lens assembly as claimed in claim 1, wherein the first surface defines a first positioning groove, the first end is matched with the first positioning groove, the second surface defines a second positioning groove, the second end is matched with the second positioning groove.

5. The lens assembly as claimed in claim 4, wherein the baffle ring further defines an opening in a radial direction of the baffle ring, the opening communicates with the pouring space, and the opening is located between the first surface and the second surface in the assembly direction.

6. The lens assembly as claimed in claim 4, wherein a width of a cross section of the second end is smaller than a width of a cross section of the second positioning groove.

7. The lens assembly as claimed in claim 4, wherein the first lens further comprises a first optical portion and a first connection portion, the first connection portion is set at an edge of the first optical portion, the first positioning groove is defined at the first connection portion, and the first positioning groove is spaced from the first optical portion, and
the second lens comprises a second optical portion and a second connection portion, the second connection portion is set at an edge of the second optical portion, the second positioning groove is defined at the second connection portion, the second positioning groove is set at intervals with the second optical portion.

8. The lens assembly as claimed in claim 7, further comprising connecting sections, wherein a first connection section of the connecting sections is arranged between the first positioning groove and the first end, a second connection section of the connecting sections is arranged between the second positioning groove and the second end.

9. The lens assembly as claimed in claim 8, wherein a maximum depth of the first positioning groove is greater than twice a thickness of the first connecting sections.

10. The lens assembly as claimed in claim 8, wherein a maximum depth of the first positioning groove is less than half of a thickness of the first connection portion.

11. The lens assembly as claimed in claim 8, wherein a width of the first positioning groove is greater than a width of the baffle ring on a shaft section, the width of the first positioning groove is less than half of a width of the first connecting part, and the width of the first positioning groove is less than a width of the first end.

12. The lens assembly as claimed in claim 11, wherein a spacing between the first positioning groove and an outside of the first optical portion is not less than 1 mm.

13. A processing method of lens assembly, comprising:
providing a first lens and a second lens arranged at intervals, in the assembly direction, facing a first surface of the first lens toward the second lens, facing a second surface of the second lens toward the first lens;
arranging a baffle ring between the first surface and the second surface, forming a pouring space between the first surface, the second surface, and an inner of the baffle ring, forming an opening in the baffle ring that connects to the pouring space;
connecting a first end of the baffle ring with the first surface, connecting a second end of the baffle ring with the second surface; and
injecting a pouring material from the opening into the pouring space, solidifying the pouring material in the pouring space to form a third lens.

14. The processing method as claimed in claim 13, connecting the second end of the baffle ring with the second surface further comprises:
making the second positioning groove on the second surface, placing the second lens in the baffle ring, and filling the liquid adhesive between the second positioning groove and the second end; and
moving the second lens in a radial direction of the second lens, adjusting the second end at the second positioning groove, aligning an optical axis of the first lens and an optical axis of the second lens, and adjusting a distance within a preset range, wherein the distance is between a third surface and a fourth surface, the third surface is from the first lens to the second lens, the fourth surface is from the second lens to the first lens.

15. The processing method as claimed in claim 13, wherein before injecting the pouring material, the processing method further comprising flipping an assembly of the first lens, the baffle ring, and the second lens, such that the opening faces upward along a direction of gravity.

16. The processing method as claimed in claim 13, further comprising defining a first positioning groove on the first surface, defining a second positioning groove on the second surface, and installing the first end into the first positioning groove, and installing the second end into the second positioning groove.
